(19) United States
(12) Patent Application Publication
(10) Pub. No.: US 2005/0052015 A1
(43) Pub. Date: Mar. 10, 2005

(54) Waterproof, tear-resistant accordion book with magnetic covers and method of making same

(76) Inventor: Paul Hynek, Los Angeles, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/894,401

(22) Filed: Jul. 19, 2004

Related U.S. Application Data
(63) Continuation-in-part of application No. 10/698,658, filed on Oct. 31, 2003.
(60) Provisional application No. 60/464,620, filed on Apr. 22, 2003.
(60) Provisional application No. 60/487,923, filed on Jul. 17, 2003.
(60) Provisional application No. 60/487,921, filed on Jul. 17, 2003.

(51) Int. Cl. B42D 1/00

(52) U.S. Cl. 281/15.1

(57) ABSTRACT

A waterproof, tear-resistant accordion book with magnet covers that hold the book together, and adhere to magnetically susceptible surfaces. The book comprises an accordion-folded sheet of material that is tear-resistant and waterproof and can be preprinted or can be written upon. The covers are attached to the respective outer folded portions. The book also can be made with tear-off pages that extend beyond the covers, and can also be made to float by means of a buoyant layer. An alternate embodiment of the invention utilizes a thin plastic box contains containing audio components with a built-in keypad. The user inputs key combinations as printed in the book, and by virtue of a sound chip with pre-recorded sound, can hear played hundreds of phrases or sounds.

### CROSS-REFERENCE TO RELATED APPLICATIONS

This application claims the benefit of U.S. Provisional Patent Application Ser. No. 60/464,620, filed Apr. 22, 2003; of U.S. Provisional Patent Application Ser. No. 60/487,923, filed Jul. 16, 2003; of U.S. Provisional Patent Application Ser. No. 60/487,921, filed Jul. 16, 2003; and is a continuation-in-part of Regular U.S. patent application Ser. No. 10/698,658, filed Oct. 31, 2003, which is hereby abandoned. The disclosures within these above-listed applications are incorporated herein by reference.

### FEDERALLY SPONSORED RESEARCH

Not Applicable

### SEQUENCE LISTING OR PROGRAM

Not Applicable

### BACKGROUND

1. Field of Invention

This invention relates to a method of book construction, specifically to a book construction that is waterproof and tear-resistant.

2. Discussion of Prior Art

Conventionally bound books have long been known to the art. Conventionally bound books, however, permit the reader to view only two pages at once.

Scroll-bound books, such as the Torah, also have long been known to the art. Scroll-bound books, however, do not afford the reader the ability to transfer to nonadjacent sections easily.

Books with sheet material folded accordion-style and with magnetic covers overcome these problems. Accordion-style folding allows the user to open the folds and spread all the pages flat to view a plurality of pages simultaneously. Books with sheet material folded accordion-style but without magnetic covers have been known for over twenty years. Such books often have regular paper and black and white content inside. They have no external magnetism and thus are not adhereable to a refrigerator or other magnetically attractive surface.

Magnetic covers keep the books closed without the need for additional securing means such as clasps or rubber bands, even in environments that are often packed hurriedly and haphazardly, such as purses and glove compartments. Magnetic covers also allow the books to be attached to a magnetically attractive surface such as a refrigerator door.

Fodors LLC, a wholly-owned subsidiary of Random House, Inc. based in New York N.Y., markets a line of such magnetic, accordion fold books for travelers. They have color content inside, magnet covers that hold the book together, external magnetism to adhere to other magnetically susceptible surfaces, and printed sheet material made of regular paper.

Tag-Master also markets co-branded promotional magnetic address books; these have no external magnetism. Most often, they have black and white content inside and use regular paper for the pages.

Books with magnetic covers but without the printed material folded accordion-style are also known to the art. Engel, in U.S. Pat. No. 5,702,126 (1997), shows a miniature book with a permanent magnetic cover to adhere the book to magnetically susceptible surfaces; alternatively, both covers can be permanent magnets. Engel, in U.S. Pat. No. 5,709,409 (1998), shows a spiral bound book where not only one of the covers, but the pages themselves, can incorporate permanent magnets so as both to adhere to magnetically susceptible surfaces and also to allow the selected page to remain open in the desired position.

Books of waterproof construction are also known to the art. Lackey et al., in published patent application US20020,011,729 (2001), shows a waterproof book in which readers enter personal medical data. Melcher, in published patent application US20010,041,114 (1999), teaches a waterproof book with detailed recommendations for the synthetic paper, glue, and thread; it is marketed under the trademark of “Durabooks.” Japanese Pat. No. 9-183278 (1997) to Suzuki shows waterproof books used in a variety of applications; however, these books are bound conventionally and do not have magnet covers.

Books that float are reflected in U.S. Pat. No. 5,464,253, Farrell (1995).

The above Japanese patent to Suzuki shows a children's book that can squirt water from an elephant's trunk.

Books with tear-off coupons can be seen in U.S. Pat. Nos. 1,972,665, Miller (1934), and 2,813,728, Harris (1957), and have been in the commercial marketplace as at least since 1987.

Flexible sheet material that can accept printing, which can be immersed in water, and which is virtually impossible to tear by hand is a relatively recent addition to the marketplace.

However, a small folding book with tear-resistant pages would be a welcome innovation. The present invention contemplates such a book, with the additional features of waterproofing, magnetic closing, and writeability.

### BACKGROUND—OBJECTS AND ADVANTAGES OF THE CURRENT INVENTION

Accordingly, one primary object of the present invention is to provide an improved book construction, specifically a book that allows the user to view a plurality of pages simultaneously, even in an extreme environment and where the book is subject to rough usage.

Another object of the present invention is to provide the reader with the ability to flip through the pages as with a bound book in situations where this is desirable, such as discreetly under a restaurant table.

Other objects are to provide a book:

that, once closed, automatically remains closed until the user chooses to open it;

that permits more content than other books with sheet material folded accordion-style;

that can adhere to a magnetically susceptible surface;

that although of a waterproof substance, still allows the user to write on it with either pen or pencil, and in the case of a pencil, to erase the writing when desired;

that is relatively thin when closed;

that can act as a coaster for drinking glasses, when in closed configuration;

that avoids using magnets strong enough to interfere with nearby magnetically recorded material, such as is to be found on credit cards placed close to the book;

that provide a tear-off coupon or coupons that extend from one of the folded sheet, without affecting the integrity of the main body of the book;

that is tear-and water-resistant;

that can float in water;

that can record and play back sound, including word phrases;

and that offers the reader the ability to read a plurality of pages simultaneously.

Further objects and advantages will become apparent from a consideration of the ensuing description and drawings. Note that not all embodiments of the current invention may accomplish all of the above objectives in a single embodiment. Taken as a whole, the objectives are met through different embodiments of the invention.

### SUMMARY

In accordance with the present invention a novel book or device for storing and presenting printed material comprises a single sheet of flexible, waterproof, tear-resistant, accordion-folded printed material. Material for stiffening both portions of the accordion-folded printed material is provided distal to the outermost folds. One or both pieces of the stiffening material are capable of exerting a magnetic attraction, whereby the printed material can be stored conveniently and compactly, and presented to the user under adverse conditions. The device optionally can record and play back sound, including word phrases.

### DRAWINGS—FIGURES

FIG. 1 is a perspective front view of the book construction of the present invention in a closed position.

FIG. 2 is a perspective view from the rear of the book construction of the present invention in an open position.

FIG. 3 is a side view of the book construction.

FIG. 4 shows an alternative embodiment of the book construction in partially extended position, showing tear-off coupons.

FIG. 5 shows an alternative embodiment of the book construction, illustrating its ability to float in water.

FIG. 6 is a perspective view from the rear of the book construction of the present invention in an open position.

FIG. 7 is a side view of an alternative embodiment of the present invention in a closed position, serving as a coaster for a drinking glass. The drinking glass is shown in broken lines, and is not part of the current invention.

FIG. 8 shows the same alternative embodiment of the present invention (as in FIG. 7). The book construction is shown in partially extended position, showing tear-off coupons.

FIG. 9 is a perspective view of yet another alternative embodiment of the present invention in a closed position. This view displays the rear cover of greater thickness than in the original preferred embodiment, and the front cover of even greater thickness than the rear.

FIG. 10 shows the same alternative embodiment of the present invention (as in FIG. 9). The book construction is shown in extended position, showing the front cover with keypad.

### DETAILED DESCRIPTION

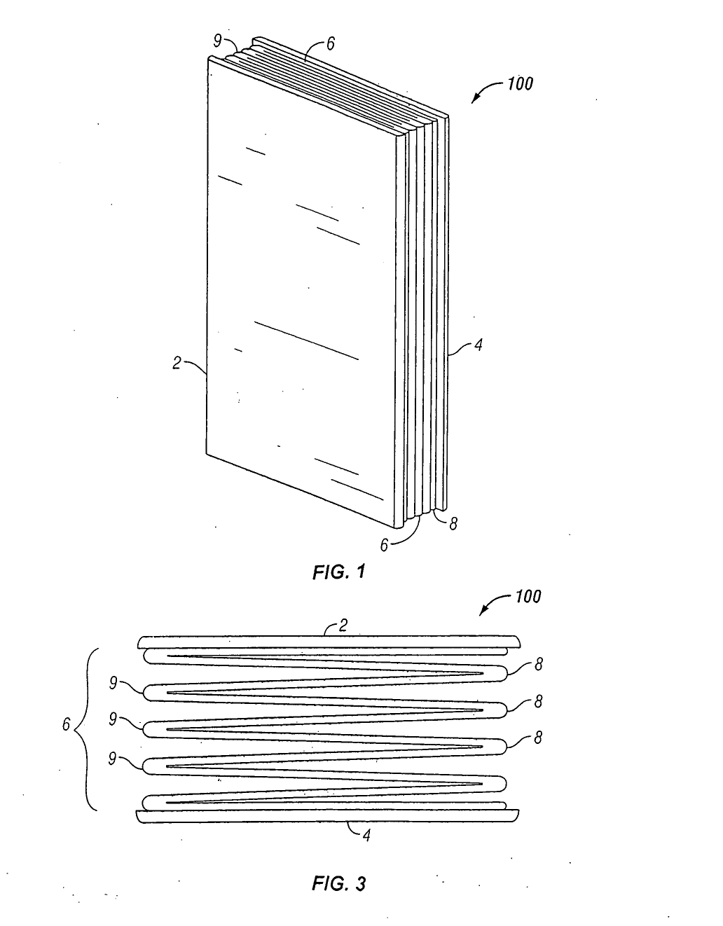

FIG. 1 shows a perspective view of the present book construction in a closed position. Although it can be made in any number of dimensions, including irregular die-cuts, a first preferred embodiment of the book construction is 8.2 cm high by 5.7 cm wide. The book is comprised of a front cover 2, a rear cover 4, and a sheet 6 that has been scored and folded so that the folds lie on one side 8 and on the other side 9 in an accordion fashion. Front cover 2 and rear cover 4 are composed of magnetic material that emits a strong enough magnetic field that, when in the closed position as shown, are drawn to each other, thereby securing folded sheet 6 in place and preventing it from opening unless the user desires to do so by forcefully separating the front and back covers enough to overcome the magnetic hold. Front and rear covers 2 and 4 have a strong enough magnetic pull to attract one another despite the presence of the intervening folded sheet material 6, yet the magnetic pull is weak enough to allow a user to easily pull the covers apart. They also allow the book to adhere to a magnetically susceptible surface such as a steel refrigerator door or an iron cabinet, yet allow the user to pull it off such surface.

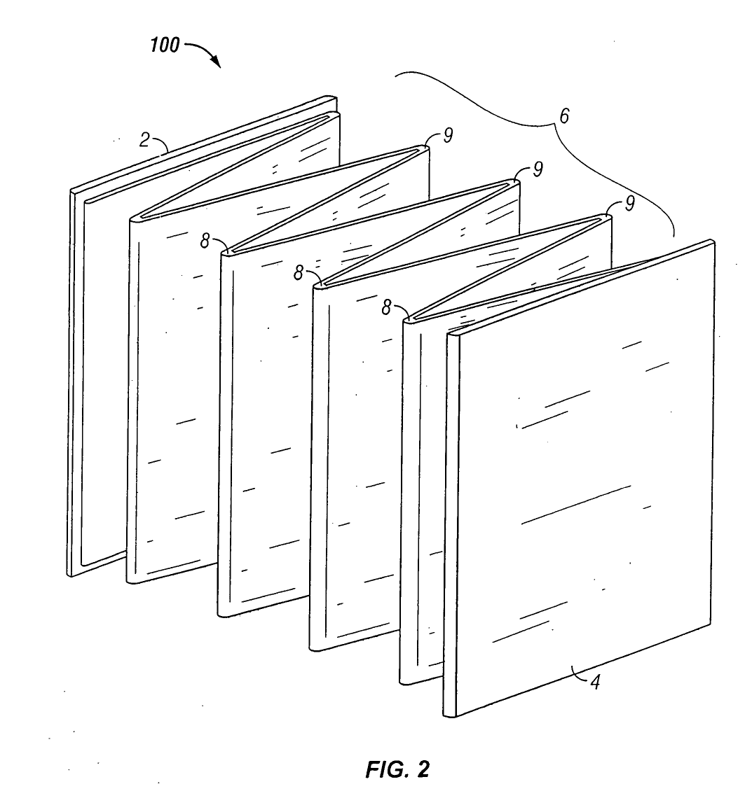

FIG. 2 shows the book in an open position. In this view the opposing sides 8 and 9 can be clearly seen. The respective ends of sheet 6 are adhered to the insides of covers 2 and 4 by adhesive. This format of book construction allows the user to view the entire contents of either side of sheet 6 at one time.

FIG. 3 shows a side view of the book construction where the folded accordion pleated sides 8 and 9 of sheet 6 are clearly seen.

The preferred embodiment for sheet 6 is Category 5 polypropylene, sold under the trademark Yupo by Yupo Corporation America, Chesapeake, Va. Other materials can be used, such as high density polyethylene, sold under the trademark Tyvek by the E.I. du Pont de Nemours Company, Wilmington, Del.; and durable polyolefin, sold under the trademark Kimdura by the Avery Dennison Corporation, Pasadena, Calif. Yupo® is preferred over Tyvek® and Kimdura® as it has superior folding qualities, is less fibrous, and importantly, has superior print quality. It is resistant to many acids, alkalis, solvents and oils, as well as water and other common liquids. It is also ISO 14001 certified, recyclable, and remains inert in approved landfills.

Sustained experimentation showed that the presently preferred thickness of sheet 6 is 0.009 cm. Thicker weights require stronger magnetic covers 2 and 4, which results in increased price, more potential negative externalities regarding interference with nearby magnetic media, and difficulty in separating the covers 2 and 4 for those whose digital strength and/or dexterity is not great. Thinner weights do not provide adequate opacity.

The permanent magnetic covers are relatively stiff, affording firmness to the product. The presently preferred embodiment for magnetic covers 2 and 4 is anisotropic rubber. The magnetic strength emitted towards sheet 6 is stronger than that emitted towards front and rear cover materials 10 and 16 so as to securely hold the book together, allow the book to adhere to a magnetically attractive surface, but not emit so much magnetic strength to the outside so as to cause as little interference with items such as credit cards etc., although AlNiCo and others are possible choices as well.

The synthetic material is also preferably affixed to the outsides of the magnetic covers, which are 0.6 mm thick, but can also be either 0.8 mm or 1.0 mm, thus making the covers effectively waterproof.

A thin coat of varnish, or similar substance, is applied to the surface of the synthetic material on both front and rear covers 2 and 4 and sheet 6, in order to prevent scuffing and fading.

### OPERATION OF FIRST EMBODIMENT—FIGS. 1-3

Front cover and rear covers 2 and 4 serve to stiffen and protect sheet 6. They can be made of magnetic material or non-magnetic material, as required.

The book is opened by pulling front and rear covers 2 and 4 sufficiently apart to overcome their magnetic attraction for each other. Pulling front and rear covers 2 and 4 further apart serves to spread accordion-folded sheet 6, thus making sheet 6 flat and making visible the printed material thereon. The book is closed by bringing together front and rear covers 2 and 4, thus allowing sheet 6 to regain its accordion pleat, and thus allowing front and rear covers 2 and 4 to again attract each other magnetically.

Advantages

From the description above, a number of advantages of the waterproof, tear-resistant accordion book of the current invention become evident:

(a) Magnetic front and rear covers 2 and 4 keep the books closed without the need for additional securing means such as clasps or rubber bands, even in environments that are often packed hurriedly and haphazardly, such as purses and glove compartments. Magnetic front and rear covers 2 and 4 also allow the books to be attached to a magnetically susceptible surface such as a refrigerator door.

(b) The information on the opposite side of sheet 6 can be printed upside down with respect to the front side. This format allows the user to more quickly access the information on the reverse side. My research has shown that, when the printed material is arranged in a vertical plane such that the covers are separated horizontally, rotating it 180° about a horizontal axis is effected more quickly than rotating it 180° about a vertical axis.

(c) Because these books are waterproof, and because tear-resistant material is used for sheet 6, they can withstand rough usage and inadvertent spillage by young children. Such books are also perfectly suited for the armed forces, or for outdoor activities such as camping and scuba diving, as well as being handy nautical reference guides that magnetically adhere to steel boat dashboards.

(d) Because the material used for sheet 6 is tougher than conventional paper, it can be made thinner and still retain adequate durability. Because sheet 6 can be made thinner, more folds can be made it (akin to permitting more pages in a conventionally bound book) within a given thickness of book. There is a distinct limit to the cover-to-cover spacing of any book that is intended to be kept closed by means of its magnetic covers. Thus, stronger sheet material permits thinner sheet material, which permits more folds in the sheet material (akin to more pages), which permits more book content.

(e) Alternatively, the thinness of sheet 6 afforded by the toughness of its material permits a book with a given number of folds in it (akin to a fixed number of pages in a conventionally bound book) to be made thinner. This, in turn, permits front and rear covers 2 and 4 to be made with less magnetic intensity while still performing adequately their intended functions of (1) keeping the closed book closed and (2) attaching it to a vertically oriented, magnetically susceptible surface such as a refrigerator door. Magnets of lower strength are not only less expensive, but they are also less likely to damage magnetically vulnerable materials, such as credit cards, in their vicinity. This advantage is specific to the combination of accordion books with magnetic covers and thin sheet 6 permitted by the high strength of the waterproof, tear-resistant material; this advantage constitutes an unexpected result of this novel combination.

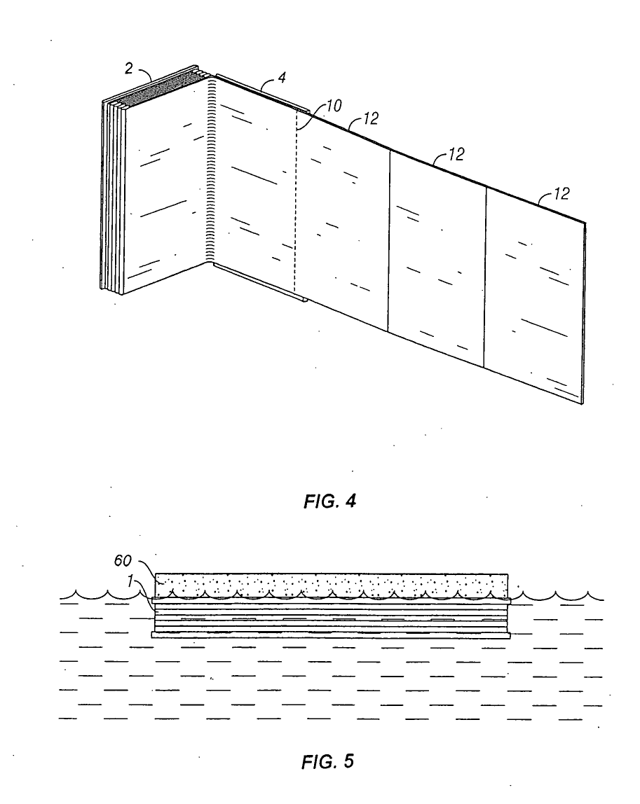

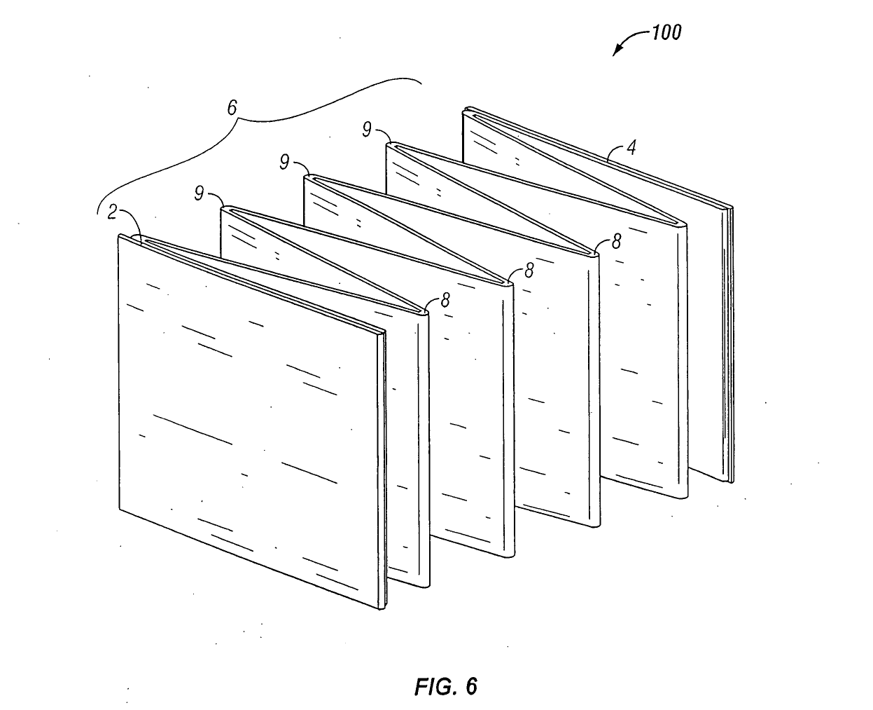

### DETAILED DESCRIPTION—ALTERNATIVE EMBODIMENTS—FIGS. 4-5

FIG. 4 shows an alternative embodiment where sheet 6 extends beyond rear cover 4. This extension of sheet 6 is folded into several additional pages 12, all of which can be removed by the reader at a line of perforations 10, so that the part of the book between front and rear covers 2 and 4 maintains its structural integrity. The book is otherwise similar to that of the first embodiment.

FIG. 5 shows an alternative embodiment where a buoyant layer 60 is affixed to the outside of the book so as to enable the book to float in water. Cork was found to have insufficient buoyancy; that is, it required an excessively thick layer of cork to render the book buoyant. It is advantageous to have layer 60 in approximately the same width and length as the book itself, and approximately one and a half times as thick as the book. It can be affixed to front cover 2 or rear cover 4. A sheet of synthetic material is then applied on its outmost face to serve as the front cover. This method still allows the book to be magnetically adhered to a magnetically susceptible surface via rear cover 4. Waterproof glue can be employed to attach front and rear covers 2 and 4 to buoyant layer 60, thus enabling the entire book to stay underwater for months and more. The portion of the book outside the buoyant layer 60 is denoted as 1. An inflatable cover can also be used to provide buoyancy.

### OPERATION—ALTERNATIVE EMBODIMENTS FIGS. 4-5

The user, upon opening the book in FIG. 4 encounters, in this example, three additional pages 12 extending from the right-most edge of sheet 6. More than three additional pages 12 extending from the right-most edge, and/or additional pages can extend from the left-most edge, and/or additional pages can extend from the top and/or bottom. In any of these cases, the user can detach a coupon, registration form, or other form of interactive or informational material while not affecting the overall structural integrity of the book.

### DETAILED DESCRIPTION—ALTERNATIVE EMBODIMENTS—FIGS. 6-8

FIG. 6 displays an alternate embodiment of the current invention that is more compact than a conventional book. The preferred size is 3.5×3.5 inches. This smaller size still affords plenty of usable, and printable, area, yet maintains an affordable price point.

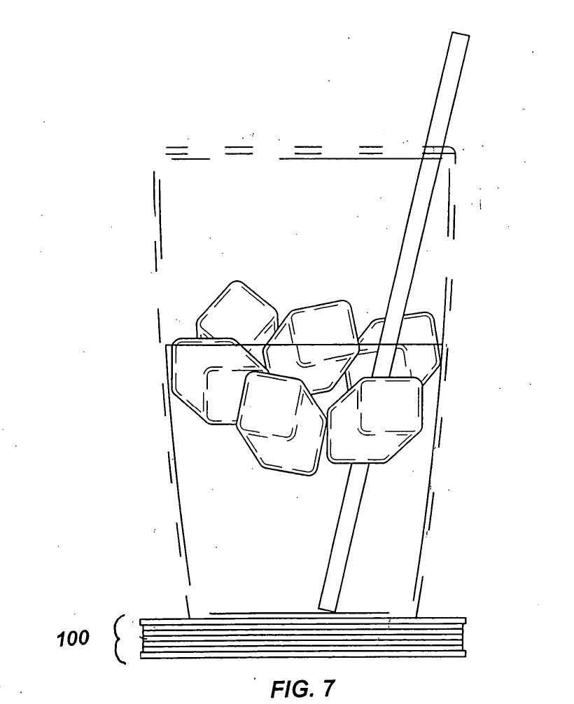

Except for dimensions, the compact version appears in extended mode similar to the first embodiment of FIG. 1. It is in the closed configuration that the compact embodiment shows its versatility. As seen in FIG. 7, the compact version serves as a coaster. When coaster service is no longer required, the compact version resumes service as a book.

Although all embodiments of the present invention have magnetic covers, the compact version is much more conveniently placed on the side of a suitable ferrous vertical surface, such as is found on refrigerators and other major appliances. This is especially important if you want the information contained within the book readily available at all times. This would be the case, for instance, in emergency CPR or first aid information. This can be printed in the compact version, and held in place on the kitchen refrigerator, ready for consultation at a moment's notice. Also, important telephone numbers for local emergency contact can be written within the book, and later readily located very quickly.

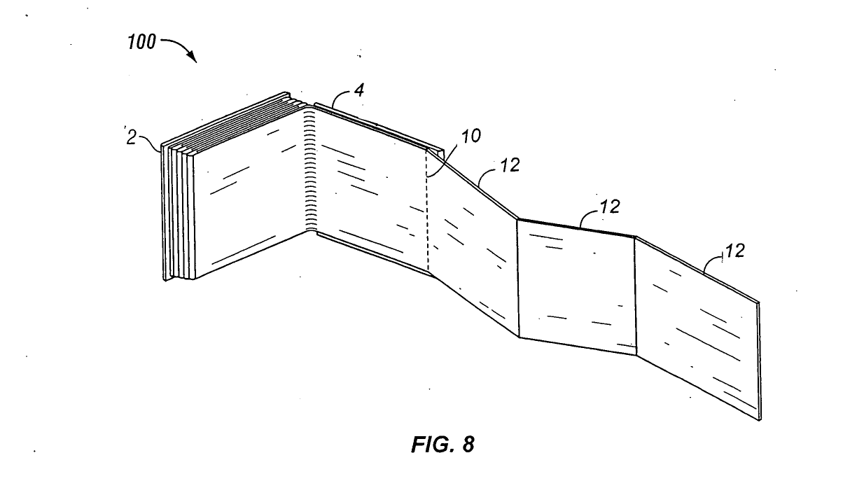

The compact book embodiment can also comprise an extended, pull-out and tearaway collection of coupons or other removable pages, for instance for notes or shopping lists. This is demonstrated in FIG. 8. This can either be accomplished with perforations in the sheet material, or with another, separate sheet material attached next to the original sheet material, with a different kind of adhesive so as to allow the user to easily remove it.

In one embodiment of the compact version, the book has a lenticular cover. A lenticular is a digitally interlaced printed or photographed image, combined with specially designed ribbed lenticular lens. It is an optical grade clear lens resting over a graphic design. The digital interlacing creates the illusion of either depth and/or motion. The lens material can be made of plastic, vinyl, acrylics, and other materials. The preferred embodiment of the lens material is plastic, such as that made by National Graphics, of Brookfield, Wis.

The lenticular cover can also be employed in the larger book version, although it is more economical and available in the 3.5×3.5 inches size of the compact embodiment.

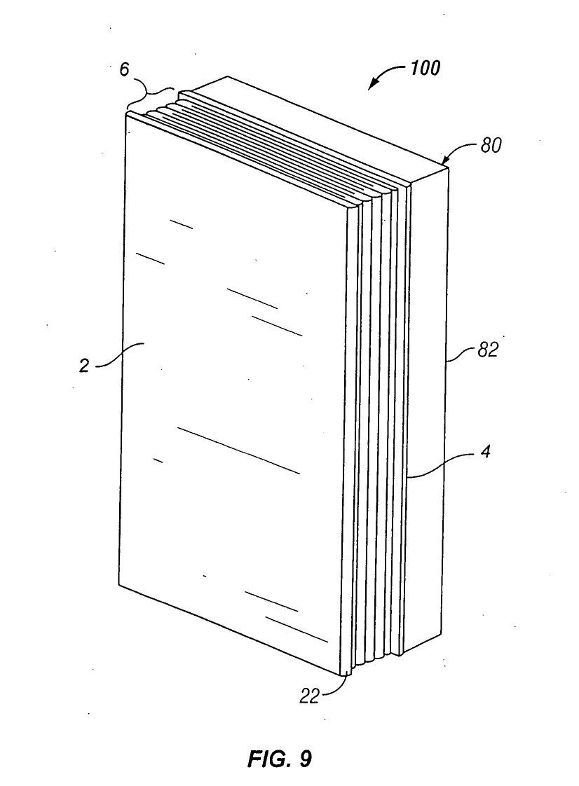

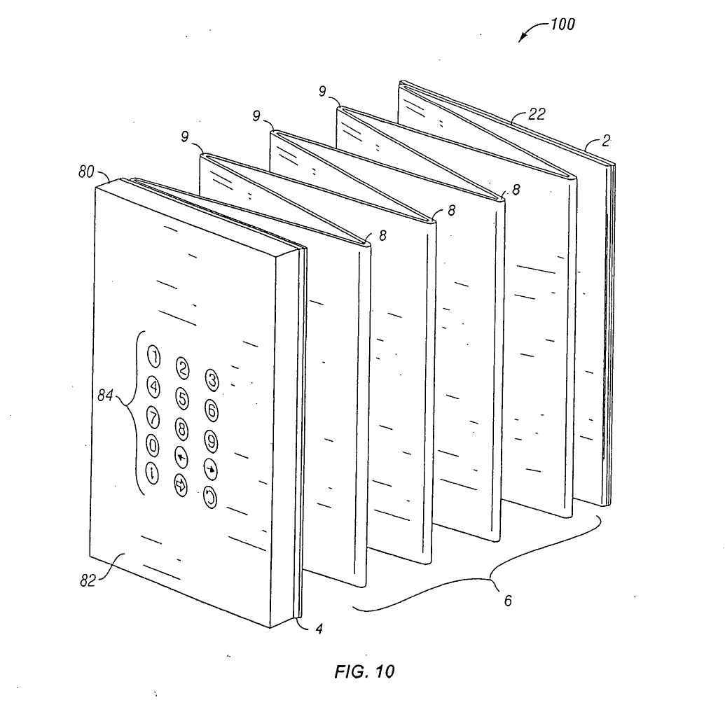

### DETAILED DESCRIPTION—ALTERNATIVE EMBODIMENTS—FIGS. 9-10

Yet another embodiment of the current invention incorporates a sound chip. When in closed configuration, as in FIG. 9, this version looks very similar to the floatable version displayed in FIG. 5. It has a specially reinforced back cover 20, with inner cover 22. The front cover 80 is also thicker, from front surface to inner cover 30. Although various dimensions are possible and functional, the preferred dimensions for the front inner cover 30, rear inner cover 22, and audio box 80 are 3.25″ high by 2.25″ wide. This makes the audio book 100 easy to put in a pocket, purse, or knapsack.

Although various thicknesses also are possible, the preferred thickness of the audio box 80 is between 0.25″ and 0.375″. This allows enough space for the internal components, yet maintains a thin enough dimension so as to still be easily portable.

Various materials are possible for the front and rear covers 20, 30, yet the preferred material is flexible magnets, so as to hold the book 60 together, and also so that the front cover 20 can adhere to a magnetically attractive surface such as a refrigerator.

Regarding the electronic components, clearly many different components can be used. The preferred sound chip is one of the SC-6x series made by Sensory, Inc. of Santa Clara, Calif., most particularly, the SC-605. This line of sound chips offers several important functionalities, including high-quality sound output, with, currently, 2.36 Mbit (288 KByte) ROM that provides up to 37 minutes of recorded sound. The SC-605 also has a compact footprint, robust programming capabilities, and an economical price.

The necessary power preferably will range between three and seven volts. This power can be supplied by any of several kinds of button cell batteries, such as lithium ones made by Shenzhen Malintech Industrial Co. of ShenZhen, China.

Various types of sound output mechanisms can be used, but preferred is a piezoelectric speaker, such as those made by Taiyo Yuden, U.S.A, of San Marcos, Calif. Such speakers are 0.7 mm or thinner, require no magnets for operation, and provide sound output rated from 74079 dB min.

The device contains an integrated circuit board, which is common in the art. Because the device will have an integrated circuit board, self-contained power supply, and keypad, other features are also presently contemplated. These include an LCD display with a digital watch, a currency calculator, and a pedometer. The pedometer would require the inclusion of a motion switch, such as those made by Comus International, of Clifton, N.J.

The audio box keypad 84 is displayed in FIG. 10 as part of a fron perspective view of the . The keypad 84 will function in concert with the content in the book 100 as follows. Inside the book 100, on various pages of the sheet material 50, there will be imprinted various phrases or passages with indications that there is accompanying audio information. The index for the relevant sound will likely, although it can be in other forms, be a number, for example ‘163.’ The user will then input ‘163’ on the audio box keypad 84, and will then hear the accompanying audio information.

The audio box keypad 84 may or may not appear as rendered in FIG. 10. It is presently contemplated to include, in addition to the numbers 0-9, these buttons:

-Previous -Next -“info”—This will play a default preface to the selected sound. (This button is described further in “Objects and Advantages.”) -Play -Replay

Various applications are evident:

For a user going to France, a book will be offered for sale that can play a selection from a comprehensive listing of hundreds of important French phrases, such as “I would like a reasonably-priced bottle of red wine to go with this steak, please” that would be printed in the book, 60. Next to this phrase would be a number, for example, ‘147.’ The user would then input ‘147’ on the audio box keypad 84, and the above phrase would be clearly audible in perfect French. For people traveling abroad, who don't speak the language of the country in which they find themselves, this is a good way to gain the goodwill of the local inhabitants, in addition to communicating complicated ideas and avoiding misunderstandings. Since local inhabitants won't expect to hear French coming out of a small pocket item, the “info” button, if depressed, will first play a brief phrase of explanation, such as “Excuse me, but I don't speak French. Will you please listen to this recording of what I'd like to say? Thank you.” After a pause of perhaps three seconds, the selected phrase will then play. (And perhaps there would also be a choice of preface phrases.)

For a museum visitor, a book will be offered for sale that comprises a small picture book devoted to the description of a given exhibition, showing images and giving explanatory text. Then with the same mechanism of numbers as explained above, or something different, the artist(s) could then give more information in their own voices about the art and exhibition.

For a sports fan, a book will be offered for sale that has the schedule for the upcoming season, stadium and ticket info, the player's jersey numbers that provide lifetime statistics, as well as recorded sayings from all the players.

Clearly other uses are possible as well, both educational and entertaining

### CONCLUSION, RAMIFICATIONS, AND SCOPE OF INVENTION

Thus the reader will see that the construction of the current invention provides a compact, durable, convenient, and waterproof item well suited to numerous purposes, both indoors and outdoors. The reader can view a plurality of pages simultaneously or flip through pages, as desired. Once closed, the book remains closed magnetically. The book can adhere to a magnetically susceptible surface. The book is waterproof, and can be made to float. The sheet material of this book is tear resistant, except when perforated to provide tear-off coupons. It can in some embodiments serve as a coaster. In other embodiments, it can reproduce sound bites.

However, the present invention confers a further advantage that is more than merely the sum of the advantages enjoyed by books with sheet material folded accordion-style and with magnetic covers, and of the advantages enjoyed by using waterproof, tear-resistant sheet material in a book. This important, additional advantage, which accrues specifically to the use of such durable sheet material in books with sheet material folded accordion-style and with magnetic covers, is that the books can contain more printed content. The high strength of the sheet material in the present invention permits the use of much thinner sheet material than is possible with ordinary cellulosic paper, hence more printed content in a book of a given thickness.

This waterproof, tear-resistant sheet material is so strong, in fact, that the minimum thickness of it that is employed in the preferred embodiment is not determined by strength. Were the synthetic material of the preferred embodiment made so thin that its strength equaled that of ordinary paper, it would be insufficiently opaque to prevent the printing on the reverse side from being visible on the front side whenever light was incident on the back side. Opacity considerations thus dictate that the minimum usable thickness of the synthetic material, while much less than that of ordinary paper, be enough that it is much stronger than ordinary paper.

While the above description contains many specificities, these should not be construed as limitations on the scope of the invention, but rather as exemplifications of one preferred embodiment thereof. Many other variations are possible. For example, the size can be bigger or smaller than that suggested in this application. The book can also have an irregular shape; for example, it can be die-cut into the planar projection of anything from an automobile to a pizza box to a beverage glass. Various materials other than Category 5 polypropylene can be applied to the outside of front cover 2, such as leather, plastic, etc., to give a different feel or functionality.

Instead of employing buoyant layer 60, the book can also be made to float with a pocket of trapped air, or with various kinds of foam of some kind, which, for example, can be looped through a small hole in one of the corners of the book.

Magnets may also be omitted, for example, when the book is intended to be slipped into a wallet or purse. In this situation, a thin sleeve, made of plastic or other materials, would serve to protect the book and keep it compacted when extracted from a wallet or purse.

Thus the scope of the invention should be determined by the appended claims and their legal equivalents, rather than by the examples given.

1. A book for storing and presenting printed material comprising:
at least a single sheet of flexible, waterproof, tear-resistant, accordion-folded material; said sheet having a plurality of folds dividing said sheet into portions, including two outermost portions; and,
a means for stiffening said outermost portions of said accordion-folded printed material, at least one of said stiffening means exerting a magnetic attraction;
whereby said book can be stored conveniently and compactly, and used under adverse conditions.

2. The book of claim 1 wherein said sheet of flexible, waterproof, tear-resistant material is made of a synthetic material.

3. The book of claim 2 wherein said synthetic material is multi-layered polypropylene.

4. The book of claim 1 wherein said means for stiffening comprises two sheets of material that are:
(a) more rigid than said single sheet; and
(b) attached to said outermost portions of said sheet.

5. The book of claim 4 wherein said means of attachment is waterproof adhesive.

6. The book of claim 1 wherein both of said means for stiffening exert a magnetic attraction and said magnetic attraction exerted by said one of said stiffening means is directed primarily toward the other said stiffening means when said book is closed.

7. The book of claim 1, further including means for rendering said book buoyant in water, comprising fitting the book with a cover comprised of low-density, buoyant material.

8. The book of claim 7 wherein said means for rendering said device buoyant in water comprises of a layer of buoyant material that is attached to said book by adhesive.

9. The book of claim 8 wherein said adhesive is substantially waterproof.

10. The book of claim 1 wherein at least one outer cover comprises a lenticular cover.

11. The book of claim 10 wherein a sheet
can accept a pencil mark;
can be erased when a pencil mark is made thereon; and
can accept ink.

12. The book of claim 1, further including an additional portion of flexible, waterproof, tear-resistant material that extends from one of said stiffening means, said additional portion being removable from the rest of the book of claim 1.

13. The book of claim 12 wherein said additional portion of flexible, waterproof, tear-resistant material is attached to the rest of said sheet by a multiplicity of perforations, so that it can readily be removed.

14. The book of claim 12, further including additional means for rendering portions of said additional flexible, waterproof, tear-resistant material readily removable from each other.

15. The book of claim 14 wherein said additional means for rendering portions of said additional flexible, waterproof, tear-resistant material readily removable from each other each comprise a multiplicity of perforations in said additional flexible, waterproof, tear-resistant material.

16. A book for storing and presenting printed material, comprising a single sheet of flexible, waterproof, tear-resistant, accordion-folded material, said sheet having a plurality of folds dividing said sheet into portions, including two outermost portions, at least one of said outermost portions of said accordion-folded printed material exerting a magnetic attraction, whereby said book can be stored conveniently and compactly, and used under adverse conditions.

17. The book of claim 16 wherein said sheet of flexible, waterproof, tear-resistant material is made of a synthetic material.

18. The book of claim 17 wherein said synthetic material is multi-layered polypropylene.

19. The book of claim 16, further including means for rendering said book buoyant in water.

20. The book of claim 16, further including an additional portion of flexible, waterproof, tear-resistant material that extends from one of said stiffening means, said additional portion is attached to the rest of said sheet by a multiplicity of perforations, so that it can be removed.

21. A device for storing and presenting printed material comprising:
(a.) a single sheet of flexible, waterproof, tear-resistant, accordion-folded printed material,
(b.) a means for stiffening both portions of said accordion-folded printed material that are distal to the outermost folds, one or both of said stiffening means being capable of exerting a magnetic attraction, and
(c.) a means for increasing the static coefficient of friction of either or both of said stiffening means when in contact with a hard, but wet, surface, whereby the printed material can be stored conveniently and compactly, yet open when desired to reveal said accordion-folded printed material, and whereby the device can serve both to protect the surface beneath a beverage glass and to prevent said beverage glass from slipping readily on said surface.

22. A device for storing and presenting printed and aural material comprising:
a single sheet of flexible, waterproof, tear-resistant, accordion-folded printed material;
a means for stiffening both portions of said accordion-folded printed material that are distal to the outermost folds, one or both of said stiffening means being capable of exerting a magnetic attraction;
an electronic means for storing and reproducing said aural material,
whereby the related said printed and aural material can be stored conveniently and compactly; and
an electronic means for allowing the user to review said printed material, and
select and then listen to desired corresponding aural material.
